(19) United States
(12) Patent Application Publication
(10) Pub. No.: US 2026/0220609 A1
(43) Pub. Date: Jul. 30, 2026

(54) TALENTED PERSON INFORMATION PROVIDING SYSTEM, TALENTED PERSON INFORMATION PROVIDING METHOD, AND STORAGE MEDIUM

(71) Applicant: NCE Corporation, Tokyo (JP)

(72) Inventors: Hiroko TANAKA, Tokyo (JP); Naohisa HASHIMOTO, Tokyo (JP); Masahiro KATSUKI, Tokyo (JP); Shinji OHNISHI, Tokyo (JP)

(73) Assignee: NCE Corporation, Tokyo (JP)

(21) Appl. No.: 19/444,386

(22) Filed: Jan. 9, 2026

(30) Foreign Application Priority Data
Jan. 30, 2025 (JP) 2025-013501

(51) Int. Cl. G06Q 10/1053; G06V 20/62; G06V 20/40

(52) U.S. Cl. CPC G06Q 10/1053; G06V 20/62; G06V 20/46; G06V 20/49

(57) ABSTRACT

Person information including at least a person name and a title extracted from content data is acquired, a skill evaluation of a person included in the person information is performed, based on the title included in the person information and attribute information in the content data, and talented person information including the person information and an evaluation result of the skill evaluation of the person included in the person information is disclosed.

This application is based upon and claims the benefit of priority from Japanese patent application No. 2025-013501, filed on January 30, 2025, the disclosure of which is incorporated herein in its entirety by reference.

### TECHNICAL FIELD

The present disclosure relates to a talented person information providing system, a talented person information providing method, and a program.

### BACKGROUND ART

JP 2008-294943 A discloses a technique in which in order to record a received program content, analysis is performed on the program content to extract key information for retrieving, access is performed to a retrieval device, an acquisition source of information related to the extracted key is retrieved, and the information related to the extracted key information is accumulated in a program additional information recording unit as program additional information.

JP 2008-294943 A describes that an end roll (end) of a program is detected from moving image data and the end roll includes information such as a performer, a member of staff, a product, and a company name related to the program.

### SUMMARY

Data regarding a staff roll such as the end roll of the content as described above includes a lot of pieces of information on technically skilled persons who have produced the content. There has been a demand for a technique that contributes to the career formation for the persons by effectively utilizing such pieces of information on the persons.

An object of the present disclosure is to provide a talented person information

providing system, a talented person information providing method, and a program that solve the above-described problem.

A talented person information providing system according to an aspect of the present disclosure includes: a person information acquisition means for acquiring person information including at least a person name and a title extracted from content data; an evaluation means for performing a skill evaluation of a person included in the person information, based on the title included in the person information and attribute information in the content data; and a disclosure means for disclosing talented person information including the person information and an evaluation result of the skill evaluation of the person included in the person information.

A talented person information providing method according to an aspect of the present disclosure includes: acquiring person information including at least a person name and a title extracted from content data; performing a skill evaluation of a person included in the person information, based on the title included in the person information and attribute information in the content data; and disclosing talented person information including the person information and an evaluation result of the skill evaluation of the person included in the person information.

A program according to an aspect of the present disclosure causes a computer in a talented person information providing system to function as: a person information acquisition means for acquiring person information including at least a person name and a title extracted from content data; an evaluation means for performing a skill evaluation of a person included in the person information, based on the title included in the person information and attribute information in the content data; and a disclosure means for disclosing talented person information including the person information and an evaluation result of the skill evaluation of the person included in the person information.

According to the above aspects, a technique that contributes to career formation for a person who has produced a content can be provided.

### BRIEF DESCRIPTION OF THE DRAWINGS

FIG. 1 illustrates an information processing system according to an aspect of the present disclosure;

FIG. 2 illustrates an exemplary hardware configuration of a talented person information providing system according to the aspect of the present disclosure;

FIG. 3 is a functional block diagram of the talented person information providing system according to the aspect of the present disclosure;

FIG. 4 is a transition diagram of data used by the talented person information providing system according to the aspect of the present disclosure;

FIG. 5 exemplarily illustrates a title master and a title conversion master according to the aspect of the present disclosure;

FIG. 6 illustrates a first example of person information cleansing processing according to the aspect of the present disclosure;

FIG. 7A to FIG. 7C illustrate second examples of the person information cleansing processing according to the aspect of the present disclosure;

FIG. 8 illustrates a third example of the person information cleansing processing according to the aspect of the present disclosure;

FIG. 9 is a flow chart illustrating the processing flow of the talented person information providing system according to the aspect of the present disclosure;

FIG. 10 is a diagram illustrating the configuration of a talented person information providing system according to another aspect of the present disclosure; and

FIG. 11 is a flow chart illustrating the processing flow of the talented person information providing system according to the other aspect of the present disclosure.

### EXAMPLE EMBODIMENT

Hereinafter, example embodiments will be described with reference to the drawings.

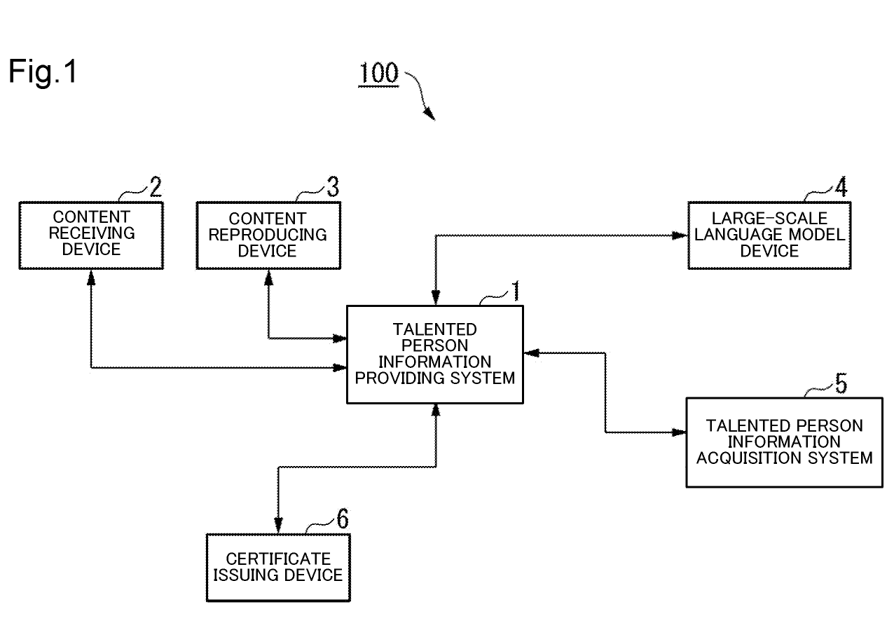

FIG. 1 illustrates an information processing system including a talented person information providing system according to an aspect of the present disclosure.

A talented person information providing system 1 is communicably connected to a content receiving device 2, a content reproducing device 3, a large-scale language model device 4, a talented person information acquisition system 5, and a certificate issuing device 6, for example. The content receiving device 2 transmits content data (e.g., broadcast data) received by broadcasting to the talented person information providing system 1. The content receiving device 2 may be, for example, a recorder that records broadcast data. The content reproducing device 3 reproduces content data (e.g., video data). The content reproducing device 3 may be, for example, a game machine.

The large-scale language model device 4 generates a result of processing instructed by prompt information using a large-scale language model and transmits the result of processing to the talented person information providing system 1. In the present disclosure, the large-scale language model device 4 extracts person information included in the content data and transmits the person information to the talented person information providing system 1.

The talented person information acquisition system 5 acquires talented person information disclosed by the talented person information providing system 1. As an example, the talented person information acquisition system 5 may be a job change site system managed by an employment agency. The certificate issuing device 6 issues a certificate for certifying, for the person who has produced the content, that the content has been produced by the person, and transmits the certificate to the talented person information providing system 1. As an example, the certificate issuing device 6 may be a device managed by a broadcast station that broadcasted broadcast data. Alternatively, the certificate issuing device 6 may be a device managed by a game company that developed a game.

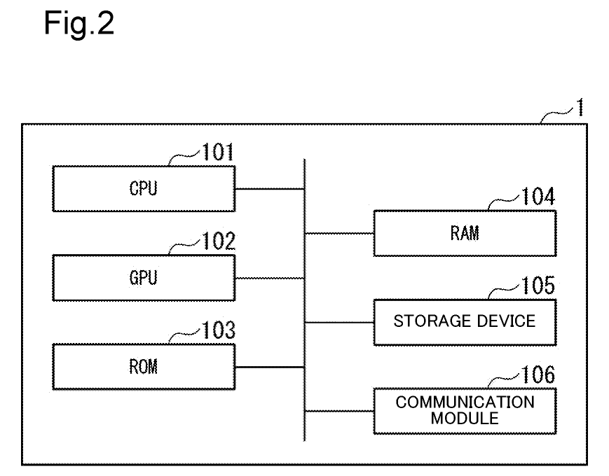

FIG. 2 illustrates an exemplary hardware configuration of the talented person information providing system according to the aspect of the present disclosure. The talented person information providing system 1 includes one or a plurality of computers, and as illustrated in FIG. 2, such a computer includes hardware such as a central processing unit (CPU) 101, a graphics processing unit (GPU) 102, a read only memory (ROM) 103, a random access memory (RAM) 104, a storage device 105 such as another hard disk drive (HDD), and a communication module 106. The content receiving device 2, the content reproducing device 3, the large-scale language model device 4, the talented person information acquisition system 5, the certificate issuing device 6, similarly, each include one or a plurality of computers and such computer has the hardware configuration illustrated in FIG. 2.

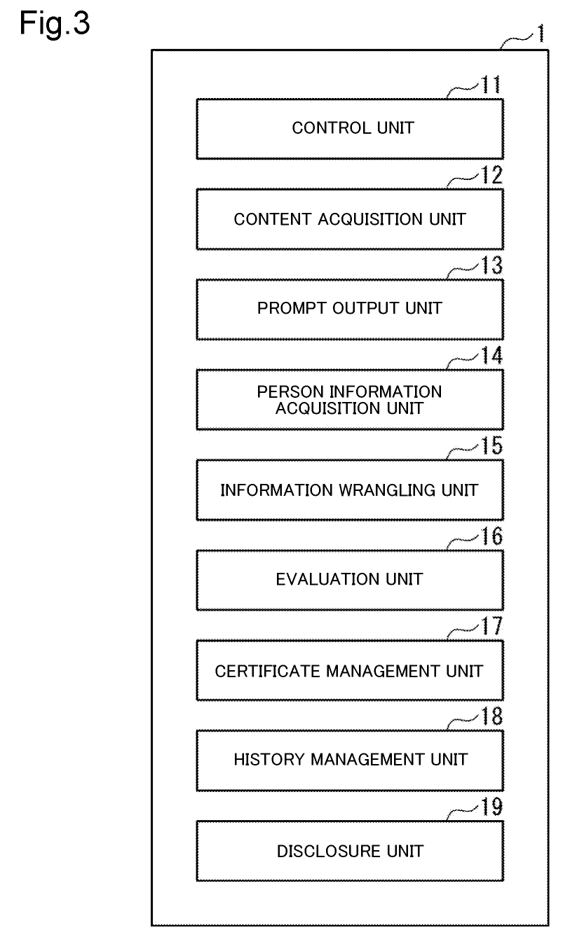

FIG. 3 is a functional block diagram of the talented person information providing system according to the aspect of the present disclosure.

The CPU 101 and the GPU 102 of the talented person information providing system 1 execute a talented person information providing program stored in advance. As a result, the talented person information providing system 1 exerts the functions of a control unit 11, a content acquisition unit 12, a prompt output unit 13, a person information acquisition unit 14, an information wrangling unit 15, an evaluation unit 16, a certificate management unit 17, a history management unit 18, and a disclosure unit 19.

The control unit 11 controls the processing units of the talented person information providing system 1. The control unit 11 may have a user interface function of communicably connecting to an external device such as a terminal used by the user through the Internet and transmitting a web page to the external device.

The content acquisition unit 12 acquires content data.

The prompt output unit 13 outputs prompt information including the content data and instruction information for making an instruction for extraction of the person information from the content data to the large-scale language model device 4.

The person information acquisition unit 14 acquires the person information including at least a person name and a title extracted from the content data.

The information wrangling unit 15 performs at least name-based aggregation on the person name included in the person information and generalization processing on the title included in the person information.

The evaluation unit 16 performs a skill evaluation of the person included in the person information, based on the title included in the person information and attribute information in the content data.

The certificate management unit 17 manages certificate information indicating that the person included in the person information has been involved in the production of the content data.

The history management unit 18 manages job-history information and others on the person included in the person information.

The disclosure unit 19 discloses the talented person information including at least the person information and the evaluation result of the skill evaluation of the person included in the person information. The disclosure unit 19 may also have a user interface function of communicably connecting to another external device such as the talented person information acquisition system 5 through the Internet and transmitting a web page and others to the external device.

The talented person information providing system 1 that exerts such functions of the processing units as described above acquires the person information including at least the person name and the title extracted from the content data; performs the skill evaluation of the person included in the person information, based on the title included in the person information and the attribute information in the content data; and discloses the talented person information including the person information and the evaluation result of the skill evaluation of the person included in the person information. The disclosure destination of the talented person information is the talented person information acquisition system 5 such as a job change site system managed by an employment agency.

Further, the talented person information providing system 1 outputs the prompt information including the content data and the instruction information for making the instruction for extraction of the person information from the content data to the large-scale language model device 4, and the large-scale language model device 4 uses the prompt information to acquire the person information extracted from the content data.

The talented person information providing system 1 may disclose the talented person information including the job-history information on the person included in the person information, in addition to the person information and the evaluation result of the skill evaluation of the person included in the person information. Further, the talented person information providing system 1 may disclose the talented person information further including the certificate information indicating that the person included in the person information has been involved in the production of the content data.

In the talented person information providing system 1 described above, in a case where the content data is broadcast data, the person information displayed on an image included in the broadcast data may be acquired. In the talented person information providing system 1 described above, in a case where the content data is record data, the person information displayed on an image included in the recorded data may be acquired. The talented person information providing system 1 may generate the evaluation result of the skill evaluation of the person included in the person information. Further, the talented person information providing system 1 performs at least the name-based aggregation on the person name included in the person information and the generalization processing on the title included in the person information.

Through such pieces of processing, the talented person information providing system 1 provides information that contributes to the career formation of persons who have produced the content to the disclosure destination and supports the career formation of the persons.

The talented person information providing system 1 acquires, as content data, the person information from the staff roll image of the broadcast content or the reproduction content (e.g., television broadcasting, a movie, a distribution moving image, or a video reproduced by a game machine), and provides a service for the skill certification of a creative talented person and for utilizing as a talented person data bank.

The service user may be a creative user having been involved in the content production, and the creative user confirms the status of his/her skill and uses the skill information for a job change activity when he/she wishes to change his/her job. The service user may be a person in charge of a recruitment company, and can approach an excellent job change candidate, based on proven achievement information.

The talented person information providing system 1 mainly focuses on the following three technologies.

### 1. Acquisition of Staff Roll Information from Video Content

In order to collect person information from content data such as television broadcasting, movies, and reproduced images of game machines, the talented person information providing system 1 converts these pieces of content data into video files, analyzes the video files using AI or OCR tools, and acquires necessary text information. The talented person information providing system 1 may extract information on a full name and a title in the staff roll from a video and acquire more detailed adjunct data (e.g., the number of persons in charge and the position of appearance) to use for skill evaluation. The talented person information providing system 1 may be able to appropriately perform data processing in accordance with the display (e.g., horizontal flow display, vertical flow display, or still image) of the staff roll appearing in the video.

### 2. Wrangling and Generalization of Person Information (Cleansing)

The talented person information providing system 1 may standardize persons identical in family name and given name and variation in title for each video content type according to the master data to improve the reliability of data. The talented person information providing system 1 may provide a conversion logic for integrating different titles into one title, based on the master data.

### 3. Talented Person Skill Evaluation

The talented person information providing system 1 may perform the skill evaluation of the person indicated by the person information by multiplying an evaluation index (e.g., viewing rate, sales, or ranking) for each content data by the weighting of the title read from the staff roll. The talented person information providing system 1 may be able to provide information on the evaluated skill to a recruiting company for the purpose of job change assistance for a suitable person at a suitable position.

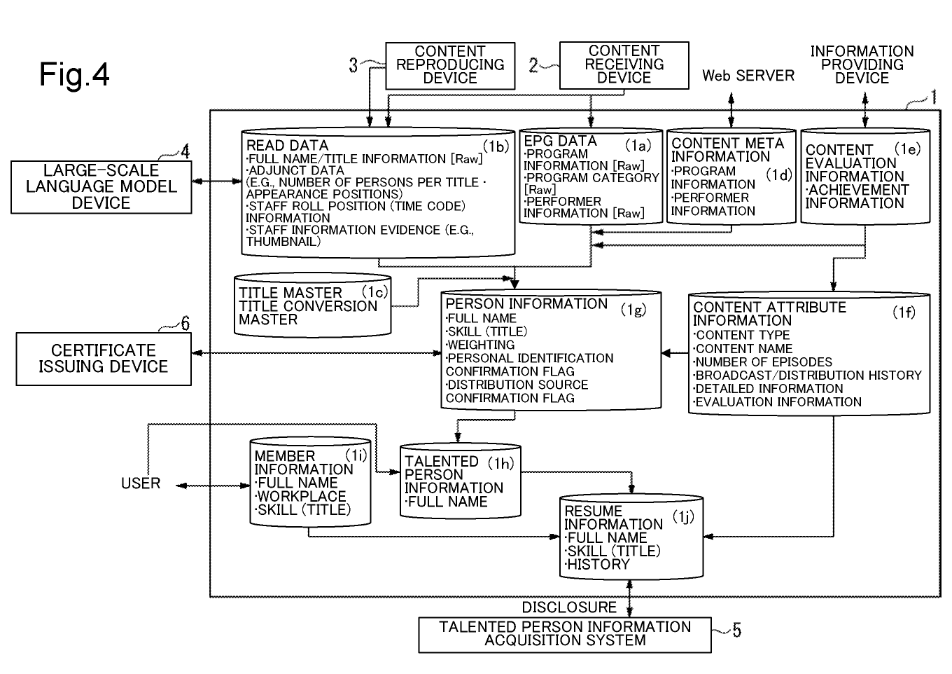

FIG. 4 is a transition diagram of data used by the talented person information providing system according to the aspect of the present disclosure.

A database 1a stores electric program guide (EPG) data extracted based on broadcast data received from the content receiving device 2. The EPG data includes program information, a program category, and performer information, and may be stored in the database 1a on a per program basis.

A database 1b stores read data read from a file in the content data received from the content receiving device 2 or the content reproducing device 3. The read data includes full name/title information, adjunct data (e.g., the number of persons per title, appearance positions (elapsed time based on broadcast start time and coordinates in images) in content, information on staff roll positions (time code), and evidence data (thumbnails) such as copies of videos with person information displayed thereon, and others, and may be stored in the database 1b on a per content basis. The read data may be information read by the talented person information providing system 1 requesting the large-scale language model device 4 to perform reading processing. The read data includes at least person information. The read data may be information manually read by an operator of the talented person information providing system 1. Alternatively, the read data may be information obtained by a reading device included in the talented person information providing system 1 analyzing a file of the content data and automatically reading the file.

A database 1c includes information on a title master and a title conversion master. The talented person information providing system 1 uses a title included in the title master and the relationship between a word included in the title conversion master and a converted title name, specifies the title information included in the read data and performs processing of converting the title information (word) into the converted title name, and generates the person information in which the title information is generalized.

A database 1d stores content meta information. The content meta information may include program information (e.g., program name and broadcast time) and performer information on the content. As an example, the content meta information may be information acquired by the talented person information providing system 1 from a web server that distributes information regarding content.

A database 1e stores content evaluation information. The content evaluation information is achievement information regarding the content, and may be, for example, a viewing rate, sales data, or the number of movie theaters. As an example, the content evaluation information may be information acquired by the talented person information providing system 1 from an information providing device that distributes the achievement information regarding the content.

A database 1f stores content attribute information. The content attribute information may include a content type, a content name, the number of episodes of the content, a broadcast history (e.g., broadcast date/time and the number of broadcasts), a distribution history (e.g., distribution date and time, the number of distributions), detailed information (e.g., a description of the content), and evaluation information (sales and viewing rate).

A database 1g stores the person information. The talented person information providing system 1 generates person information (1g) on a person who has been involved in the production of content, using the EPG data (1a), the read data (1b), content meta information (1d), content evaluation information (1e), the content attribute information (1f), and the title master and the title conversion master (1c), for example. The person information (1g) may include information such as a full name, a title (skill), and a weighting value.

The talented person information providing system 1 acquires certificate data for the person information stored in the database 1g from the certificate issuing device 6. The certificate issuing device 6 may be, for example, a server device managed by a company such as a distribution source, an issuance source, and a sales source of the content data from which the person information is extracted. When acquiring the certificate data, the talented person information providing system 1 rewrites the distribution source confirmation flag of the person information to ON. The talented person information providing system 1 may rewrite the personal identification confirmation flag to ON, and record the personal identification confirmation flag into the database 1g in a case where the approval is received from the user, based on the access from the user corresponding to the person information. The weighting value is a weighting value of the evaluation of the person, and may be a value calculated by inputting a level of the viewing rate according to the relation between the viewing rate of the content and the threshold value or an evaluation level according to the sales amount into a predetermined calculation formula.

A database 1h stores talented person information. The talented person information providing system 1 generates talented person information to be externally disclosed using the person information (1g) and registers the talented person information into the database 1h. The talented person information includes information selected from the pieces of information registered in the person information (1g). In a case where full names identical in family name and given name have been specified from read data of a plurality of contents, the talented person information providing system 1 determines that the persons identical in family name and given name have been specified from the plurality of contents are the identical person, based on whether the plurality of contents is produced by the same content production company or whether the plurality of contents is broadcasted by the same broadcast station, for example. In a case where a plurality of persons identical in family name and given name is determined to be the identical person, the talented person information providing system 1 may collectively write the person information on the person into the database 1h.

A user (e.g., a person having been involved in content production) registers his/her own information as member information into the talented person information providing system 1. The member information is registered into a database 1i. The member information may be, for example, a full name, a workplace, or skill (title) registered by the user himself/herself.

The database 1j stores job resume information generated using the talented person information (1h) and the member information (1i), for example. The talented person information providing system 1 generates a disclosure information screen including the job resume information, and responds to a request from the talented person information acquisition system 5.

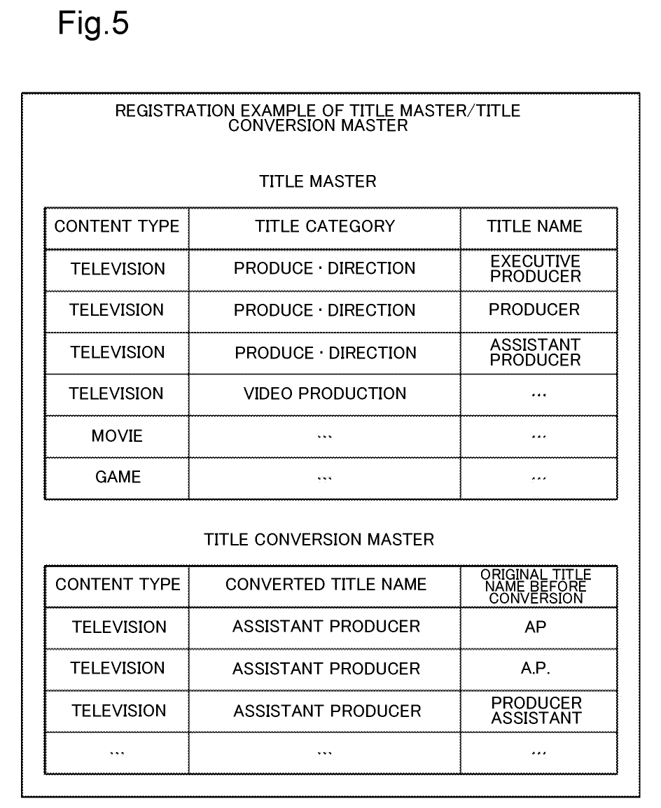

FIG. 5 exemplarily illustrates the title master and the title conversion master according to the aspect of the present disclosure.

As an example, the title master is a data table in which a content type, a title category, and a title name are stored in association with each other. As an example, the title conversion master is a data table in which a content type, a converted title name and an original title name before conversion are stored in association with each other.

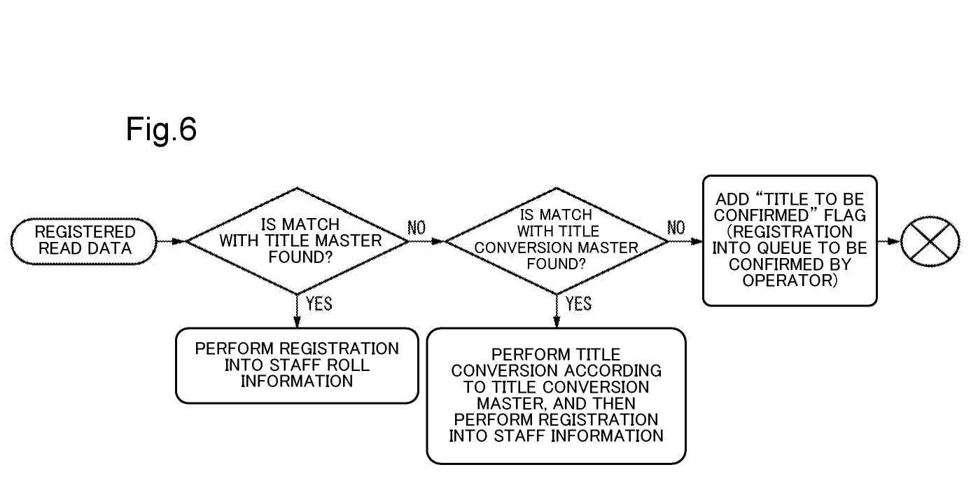

FIG. 6 illustrates a first example of person information cleansing processing according to the aspect of the present disclosure.

The talented person information providing system 1 performs a title conversion as the person information cleansing processing at the time of generating the person information (1g). First, the read data (1b) holds the title data having the name remaining read from the content such as video. The content type + the title information in the read data are collated with the title master. If a match is found therebetween, the result data is adopted as it is and registered as “person information”. Otherwise, the content type + the title information in the read data are collated with the title conversion master, and if a match with an original title name before conversion is found, conversion into a converted title name is performed and then a registration as person information is made. In the case of a new title that is also not present in the title conversion master, a flag to be confirmed is added in such a way the data needs to be determined by, for example, an operator, and the operator performs an action of adding records of the title master or the title conversion master or correcting the read data, so that the result data can be registered in the database 1g as person information.

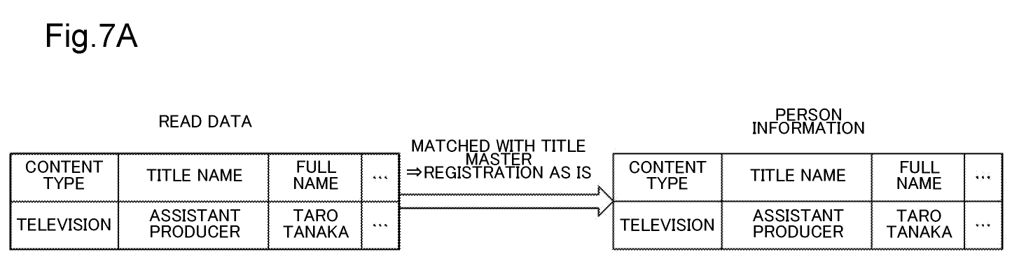

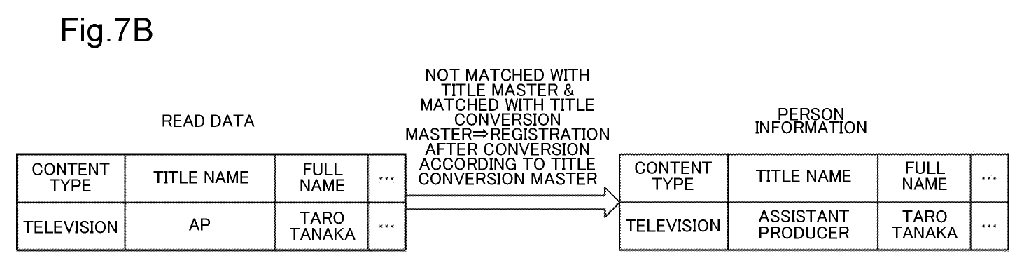

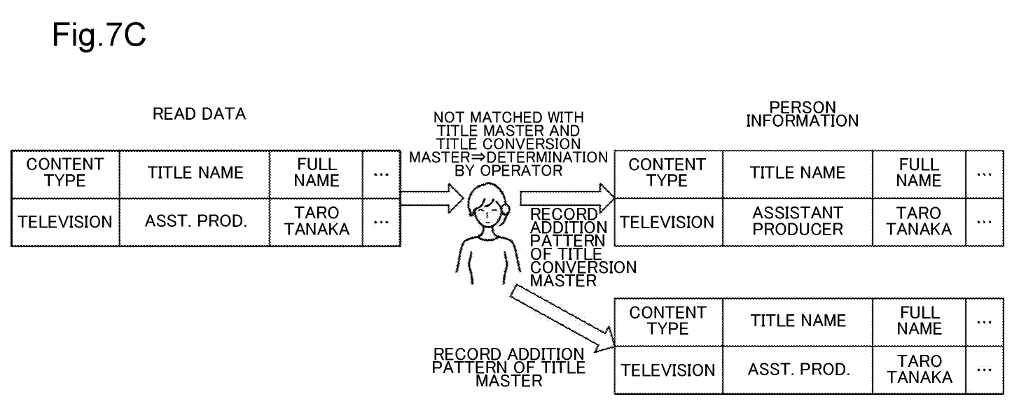

Each of FIG. 7A to FIG. 7C illustrates a second example of the person information cleansing processing according to the aspect of the present disclosure.

Describing the above-described title conversion processing in more detail, for example, in a case where the title name of the read data is “assistant producer” and the title name is registered in the title master (FIG. 7A), the title name of “assistant producer” may be registered as it is as person information. In a case where the title name of the read data is “AP” and the title name is not registered in the title master but “AP” is registered in the title conversion master (FIG. 7B), the talented person information providing system 1 converts “AP” into a character string of “assistant producer” and registers the title name of “assistant producer” as the person information read from the content data. In a case where the title name of the read data is expressed as “asst. prod.” and the title name is not registered in the title master and the title conversion master (Fig.7C), a converted title name is designated by the operator and registered in the database 1g as person information.

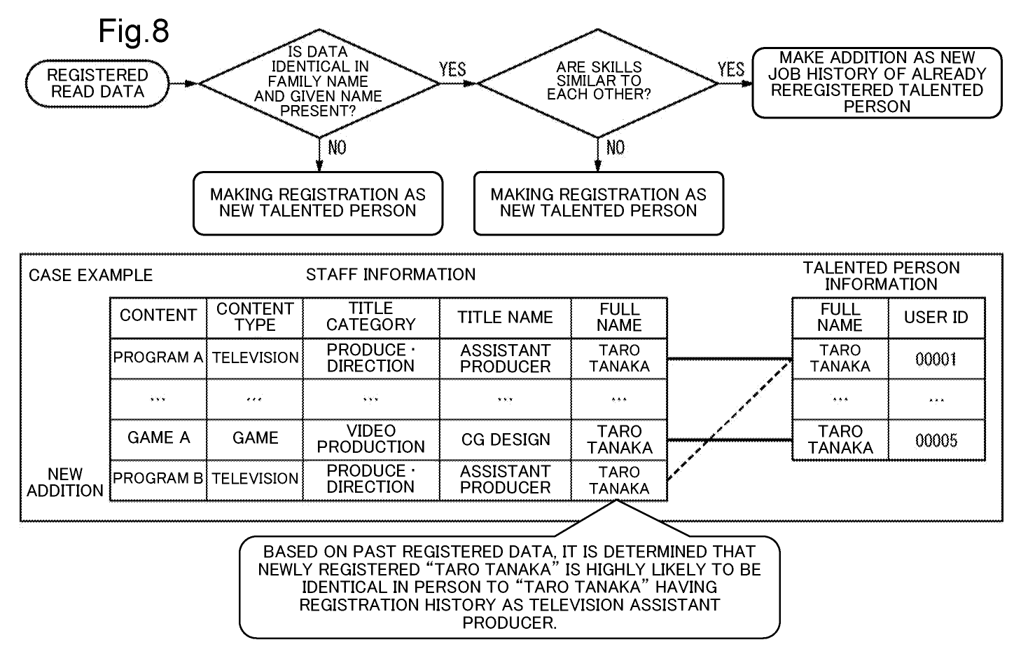

FIG. 8 illustrates a third example of the person information cleansing processing according to the aspect of the present disclosure.

When generating the person information (1g) based on the read data, the talented person information providing system 1 determines whether data identical in family name and given name to the full name indicated in the read data is already present as the person information (1g). In a case where the data identical in family name and given name is not present as person information (1g), the talented person information providing system 1 registers the data into the database 1g as person information on a new talented person. In a case where the data identical in family name and given name is present as person information (1g), the talented person information providing system 1 performs an identical person determination. In this identical person determination, the talented person information providing system 1 determines whether skills (title names) are similar to each other. Further, in the identical person determination, the talented person information providing system 1 may determine whether content production companies are the same as each other or whether sales sources are the same as each other, for example. In a case where the skills are similar to each other and the content production companies and the content sales sources are the same, it is determined as an identical person, and the information read as the read data is registered in the database 1g as the person information on the already registered talented person as job history information. In a case where it is determined as a non-identical person in the identical person determination, the information is registered into the database 1g as person information on a new talented person.

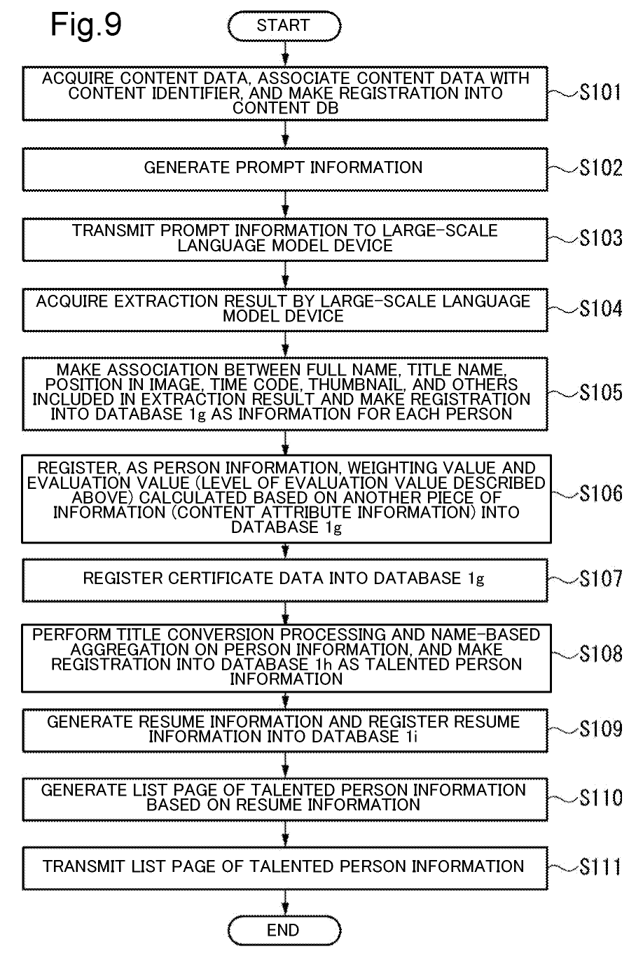

FIG. 9 is a flow chart illustrating a processing flow of the talented person information providing system according to the aspect of the present disclosure.

Next, the processing flow of the talented person information providing system will be described in order.

The content acquisition unit 12 of the talented person information providing system 1 acquires content data from the content receiving device 2 or the content reproducing device 3, and registers the content data and the content identifier into a content DB in association with each other (step S101). The content identifier is information for specifying the content data, and may be information that can be specified by information such as an ID, or a content name + a date + the number of episodes + a file number.

The prompt output unit 13 acquires one piece of content data stored in the content DB and generates prompt information (step S102). The prompt information is instruction information for requesting the large-scale language model device 4 to extract person information. In a case where the content data is a video, the prompt output unit 13 may divide the video into one-frame images. The prompt output unit 13 generates the prompt information including text such as an image displayed in content data, and extracting a person name from the image, extracting the title name of the person, specifying a position in the image obtained by reading the person name or the title name, specifying time code in which the person name or the title name appears in the video, and generating the thumbnail of the image including the person name or the title name. The prompt output unit 13 transmits the prompt information to the large-scale language model device 4 (step S103). The prompt output unit 13 may divide one piece of content data, generate a plurality of pieces of prompt information based on the division, and transmit the plurality of pieces of prompt information to the large-scale language model device 4.

The large-scale language model device 4 inputs the prompt information to a large-scale language model, and in a case where the full name of the person is included in images, the large-scale language model device 4 extracts the full name and the title name of the person from the images. The large-scale language model device 4 specifies the position in the image of the extracted person name and the time code, and extracts an image including the person name as a thumbnail. The large-scale language model device 4 generates the extraction result including the full name, the title name, the position in the image, the time code, and the thumbnail of one or a plurality of persons extracted from the content data for each person, and transmits the extraction result to the talented person information providing system 1.

The person information acquisition unit 14 of the talented person information providing system 1 acquires the extraction result generated by the large-scale language model device 4 (step S104). The person information acquisition unit 14 makes an association between the full name, the title name, the position in the image, the time code, the thumbnail, and others included in the extraction result, and makes a registration into the database 1g as information for each person (step S105). The person information acquisition unit 14 may register, into the database 1g, data resulting from an association of the person information with the identifier of the content from which the person name has been successfully extracted as the person information.

The person information acquisition unit 14 may acquire the content meta information and the content evaluation information regarding the content data corresponding to the identifier of the content associated with the person information from each of the database 1d, the database 1e, the database 1f, and the others, and register the content meta information and the content evaluation information into the database 1g as person information.

Note that the talented person information providing system 1 may acquire the content meta information and the content evaluation information from an external device (a web server or an information providing device) in advance. Alternatively, in a case where the talented person information providing system 1 can acquire the full name, the title name, and others based on the content data, the talented person information providing system 1 may newly transmit a request for providing information including the content identifier to the external device, and as a result, may acquire the content meta information and the content evaluation information. The talented person information providing system 1 registers, into the database 1f, content attribute information in which the content meta information and the content evaluation information are associated with content identification information (e.g., content name). The talented person information providing system 1 may process and newly generate person information, based on the content meta information and the content evaluation information, and may register the person information into the database 1g.

The evaluation unit 16 calculates the weighting value of the person information, based on the full name and the title of the person and the content attribute information regarding the content from which the full name has been successfully extracted. The evaluation unit 16 makes an association between the weighting value and the evaluation value (the level of the evaluation described above) calculated based on another piece of information (content attribute information), and makes a registration into the database 1g as person information (step S106).

The certificate management unit 17 transmits a certificate issuance request for the person information stored in the database 1g to the certificate issuing device 6. The certificate issuing device 6 may be, for example, a server device managed by a company such as a distribution source, an issuance source, and a sales source of the content data from which the person information is extracted. A person in charge of the company such as a distribution source, an issuance source, and a sales source of the content data issues a certificate issuance instruction for the person information included in the certificate issuance request. The certificate issuing device 6 transmits certificate issuance information including the certificate data and the identifier of the person information included in the certificate issuance request to the talented person information providing system 1. The certificate management unit 17 specifies a person, based on the identifier of the person information included in the certificate issuance information, and registers the certificate data included in the certificate issuance information into the database 1g as person information on the person (step S107).

The information wrangling unit 15 performs job title conversion processing and name-based aggregation on the person information registered in the database 1g, and makes a registration into the database 1h as talented person information (step S108). The talented person information may be information in which information selected as information to be disclosed is selected from the person information. The talented person information may include a part of the member information registered by the user as his/her own information.

The history management unit 18 specifies the correspondence relation between the talented person information registered in the database 1h and the member information registered in the database 1i, based on, for example, the full name or the title. The correspondence relation between the talented person information and the member information may be specified by the user accessing to and operating the talented person information providing system 1. The history management unit 18 generates resume information, based on the talented person information, the member information, and the content attribute information relating to the content in which the person has been involved. The history management unit 18 registers the job-history information into the database 1i (step S109). In addition to the full name, the skill (title name), the evaluation level, and others, the resume information may include a list of pieces of information on the contents that the person has been involved in production, a contact address to the person, and others. The resume information may be information created by the user's operation by the user accessing the talented person information providing system 1.

The disclosure unit 19 generates a list page of the talented person information, based on the resume information (step S110). The disclosure unit 19 receives a transmission request for the list page of the talented person information from the talented person information acquisition system 5. The disclosure unit 19 transmits the list page of the talented person information to the talented person information acquisition system 5, based on the transmission request (step S111).

Such pieces of processing are exemplary pieces of processing in which the talented person information providing system 1 acquires person information including at least a person name and a title extracted from content data; performs a skill evaluation of a person included in the person information, based on the title included in the person information and the attribute information in the content data; and discloses talented person information including the person information and an evaluation result of the skill evaluation of the person included in the person information.

As a result of the pieces of processing, a person in charge of the recruitment company that operates the talented person information acquisition system 5 can check the list page of the talented person information and perform a talented-person introduction activity according to the history of content production and the evaluation level.

According to such functions of the talented person information providing system 1 as described above, a technique that contributes to career formation of a person who has produced the content can be provided.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

The processing of the evaluation unit 16 will be supplemented. The evaluation unit 16 may calculate the skill evaluation by multiplying the evaluation index (e.g., viewing rate, sales, or ranking) for each content by the weighting of the title read from the staff roll.

### Assumption of Use of Skill Evaluation Information

For recruitment companies: Based on the evaluation result of the person, information on the evaluated skill can be provided to a recruiting company for the purpose of job change assistance for a suitable person at a suitable position.

For creative users: The users may be able to view their skill evaluations within their industry.

### Scheme of Skill Evaluation

The following pieces of information may be combined to make scoring of a job history independently in the service and used as an objective skill evaluation index.

### Importance of Title

Enabling to order the titles of creative staff according to industry convention (Producer > Assistant Producer).

Weighting by the number of staff having one title among the members of staff having been involved in the content (Evaluation in a case where the content is created by one chief producer > Evaluation in a case where the content is created by five assistant producers)

### Market Evaluation of Content and Content Scale

An evaluation index for each content (television viewing rate, content sales, evaluation of ranking information and others) is high => The skill evaluation is also considered to be high.

Substantial Feeling for Content Itself (30 minute drama < 2 hour drama)

To the person information in which the “certificate” of staff information by, for example, a content distribution source, a broadcast station, a movie distribution company, or a game production company is registered, is a “distribution source confirmed” flag is added, and the person information can be handled as skill information with higher reliability.

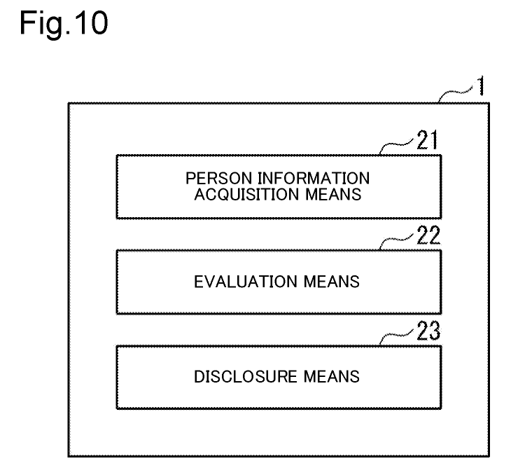

FIG. 10 is a diagram illustrating the configuration of a talented person information providing system according to another aspect of the present disclosure.

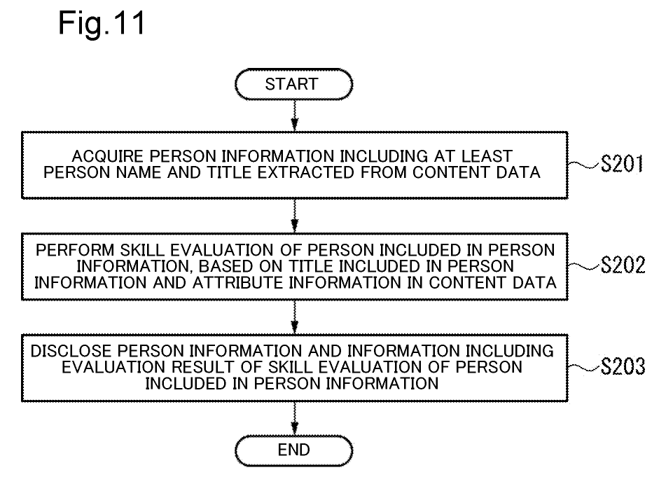

FIG. 11 is a flow chart illustrating the processing flow of the talented person information providing system according to the other aspect of the present disclosure.

According to the other aspect, the talented person information providing system includes a person information acquisition means 21, an evaluation means 22, and a disclosure means 23.

The person information acquisition means 21 acquires person information including at least a person name and a title extracted from content data (step S201).

The evaluation means 22 performs a skill evaluation of the person included in the person information, based on the title included in the person information and attribute information in the content data (step S202).

The disclosure means 23 discloses the person information and information including an evaluation result of the skill evaluation of the person included in the person information (step S203).

Some or all of the above-described example embodiments may be described as the following supplementary notes, but are not limited thereto.

### Supplementary Note 1

A talented person information providing system including:

a person information acquisition means for acquiring person information including at least a person name and a title extracted from content data;

an evaluation means for performing a skill evaluation of a person included in the person information, based on the title included in the person information and attribute information in the content data; and

a disclosure means for disclosing talented person information including the person information and an evaluation result of the skill evaluation of the person included in the person information.

### Supplementary Note 2

The talented person information providing system according to Supplementary Note 1, further including a prompt information output means for outputting prompt information including the content data and instruction information for making an instruction for extraction of the person information from the content data to a large-scale language model, in which

the person information acquisition means acquires the person information extracted from the content data by the large-scale language model using the prompt information.

### Supplementary Note 3

The talented person information providing system according to Supplementary Note 1 or 2, in which

the disclosure means discloses the talented person information including job-history information on the person included in the person information, in addition to the person information and the evaluation result of the skill evaluation of the person included in the person information.

### Supplementary Note 4

The talented person information providing system according to any one of Supplementary Note 1 to Supplementary Note 3, in which

the disclosure means discloses the talented person information including certificate information indicating that the person included in the person information has been involved in production of the content data.

### Supplementary Note 5

The talented person information providing system according to any one of Supplementary Note 1 to Supplementary Note 4, in which

the content data includes broadcast data, and

the person information acquisition means acquires the person information displayed on an image included in the broadcast data.

### Supplementary Note 6

The talented person information providing system according to any one of Supplementary Note 1 to Supplementary Note 5, in which

the content data includes record data, and

the person information acquisition means acquires the person information displayed on an image included in the record data.

### Supplementary Note 7

The talented person information providing system according to any one of Supplementary Note 1 to Supplementary Note 6, in which

the evaluation means generates the evaluation result of the skill evaluation of the person included in the person information.

### Supplementary Note 8

The talented person information providing system according to any one of Supplementary Note 1 to Supplementary Note 7, further including

a person information wrangling means for performing at least name-based aggregation on the person name included in the person information and generalization processing on the title included in the person information.

### Supplementary Note 9

A talented person information providing method including:

acquiring person information including at least a person name and a title extracted from content data;

performing a skill evaluation of a person included in the person information, based on the title included in the person information and attribute information in the content data; and

disclosing talented person information including the person information and an evaluation result of the skill evaluation of the person included in the person information.

### Supplementary Note 10

The talented person information providing method according to Supplementary Note 9 further including:

outputting prompt information including the content data and instruction information for making an instruction for extraction of the person information from the content data to a large-scale language model; and

acquiring the person information extracted from the content data by the large-scale language model using the prompt information.

### Supplementary Note 11

The talented person information providing method according to Supplementary Note 9 or 10, in which

the disclosing includes disclosing the talented person information including job-history information on the person included in the person information, in addition to the person information and the evaluation result of the skill evaluation of the person included in the person information.

### Supplementary Note 12

The talented person information providing method according to any one of Supplementary Note 9 to supplementary Note 11, in which

the disclosing includes disclosing the talented person information including certificate information indicating that the person included in the person information has been involved in production of the content data.

### Supplementary Note 13

The talented person information providing method according to any one of Supplementary Note 9 to Supplementary Note 12, in which

the content data includes broadcast data, and

the acquiring includes acquiring the person information displayed on an image included in the broadcast data.

### Supplementary Note 14

The talented person information providing method according to any one of Supplementary Note 9 to Supplementary Note 13, in which

the content data includes record data, and

the acquiring includes acquiring the person information displayed on an image included in the record data.

### Supplementary Note 15

The talented person information providing method according to any one of Supplementary Note 9 to Supplementary Note 14, further including

generating the evaluation result of the skill evaluation of the person included in the person information.

### Supplementary Note 16

The talented person information providing method according to any one of Supplementary Note 9 to Supplementary Note 15, further including

performing at least name-based aggregation on the person name included in the person information and generalization processing on the title included in the person information.

### Supplementary Note 17

A program for causing a computer in a talented person information providing system to function as:

a person information acquisition means for acquiring person information including at least a person name and a title extracted from content data;

an evaluation means for performing a skill evaluation of a person included in the person information, based on the title included in the person information and attribute information in the content data; and

a disclosure means for disclosing talented person information including the person information and an evaluation result of the skill evaluation of the person included in the person information.

### Supplementary Note 18

The program according to Supplementary Note 17 further including causing the computer to function as a prompt information output means for outputting prompt information including the content data and instruction information for making an instruction for extraction of the person information from the content data to a large-scale language model; and

the person information acquisition means acquires the person information extracted from the content data by the large-scale language model using the prompt information.

### Supplementary Note 19

The program according to Supplementary Note 17 or 18, in which

the disclosure means discloses the talented person information including job-history information on the person included in the person information, in addition to the person information and the evaluation result of the skill evaluation of the person included in the person information.

### Supplementary Note 20

The program according to any one of Supplementary Note 17 to Supplementary Note 19, in which

the disclosure means discloses the talented person information including certificate information indicating that the person included in the person information has been involved in production of the content data.

### Supplementary Note 21

The program according to any one of Supplementary Note 17 to Supplementary Note 20, in which

the content data includes broadcast data, and

the person information acquisition means acquires the person information displayed on an image included in the broadcast data.

### Supplementary Note 22

The program according to any one of Supplementary Note 17 to Supplementary Note 21, in which

the content data includes record data, and

the person information acquisition means acquires the person information displayed on an image included in the record data.

### Supplementary Note 23

The program according to any one of Supplementary Note 17 to Supplementary Note 22, in which

the evaluation means generates the evaluation result of the skill evaluation of the person included in the person information.

### Supplementary Note 24

The program according to any one of Supplementary Note 17 to Supplementary Note 23 in which

the causing further includes causing the computer in the talented person information providing system to function as a person information wrangling means for performing at least name-based aggregation on the person name included in the person information and generalization processing on the title included in the person information.

1. A talented person information providing system comprising:
a person information acquisition circuit configured to acquire person information including at least a person name and a title extracted from content data;
an evaluation circuit configured to perform a skill evaluation of a person included in the person information, based on the title included in the person information and attribute information in the content data; and
a disclosure circuit configured to disclose talented person information including the person information and an evaluation result of the skill evaluation of the person included in the person information.

2. The talented person information providing system according to claim 1, further comprising
a prompt information output circuit configured to output prompt information including the content data and instruction information for making an instruction for extraction of the person information from the content data to a large-scale language model, wherein
the person information acquisition circuit acquires the person information extracted from the content data by the large-scale language model using the prompt information.

3. The talented person information providing system according to claim 2, wherein
the disclosure circuit discloses the talented person information including job-history information on the person included in the person information, in addition to the person information and the evaluation result of the skill evaluation of the person included in the person information.

4. The talented person information providing system according to claim 3, wherein
the disclosure circuit discloses the talented person information further including certificate information indicating that the person included in the person information has been involved in production of the content data.

5. The talented person information providing system according to claim 3, wherein
the content data includes broadcast data, and
the person information acquisition circuit acquires the person information displayed on an image included in the broadcast data.

6. The talented person information providing system according to claim 3, wherein
the content data includes record data, and
the person information acquisition circuit acquires the person information displayed on an image included in the record data.

7. The talented person information providing system according to claim 5, wherein
the evaluation circuit generates the evaluation result of the skill evaluation of the person included in the person information.

8. The talented person information providing system according to claim 7, further comprising
a person information wrangling circuit configured to perform at least name-based aggregation on the person name included in the person information and generalization processing on the title included in the person information.

9. A talented person information providing method comprising;
acquiring person information including at least a person name and a title extracted from content data;
performing a skill evaluation of a person included in the person information, based on the title included in the person information and attribute information in the content data; and
disclosing talented person information including the person information and an evaluation result of the skill evaluation of the person included in the person information.

10. The talented person information providing method according to claim 9, further comprising:
outputting prompt information including the content data and instruction information for making an instruction for extraction of the person information from the content data to a large-scale language model; and
acquiring the person information extracted from the content data by the large-scale language model using the prompt information.

11. The talented person information providing method according to claim 9, wherein
the disclosing includes disclosing the talented person information including job-history information on the person included in the person information, in addition to the person information and the evaluation result of the skill evaluation of the person included in the person information.

12. The talented person information providing method according to claim 9, wherein
the disclosing includes disclosing the talented person information including certificate information indicating that the person included in the person information has been involved in production of the content data.

13. The talented person information providing method according to claim 9, wherein
the content data includes broadcast data, and
the acquiring includes acquiring the person information displayed on an image included in the broadcast data.

14. The talented person information providing method according to claim 9, wherein
the content data includes record data, and
the acquiring includes acquiring the person information displayed on an image included in the record data.

15. The talented person information providing method according to claim 9, further comprising
generating the evaluation result of the skill evaluation of the person included in the person information.

16. The talented person information providing method according to claim 9, further comprising
performing at least name-based aggregation on the person name included in the person information and generalization processing on the title included in the person information.

17. A tangible and non-transitory storage medium storing a program for causing a computer in a talented person information providing system to function as:
a person information acquisition means for acquiring person information including at least a person name and a title extracted from content data;
an evaluation means for performing a skill evaluation of a person included in the person information, based on the title included in the person information and attribute information in the content data; and
a disclosure means for disclosing talented person information including the person information and an evaluation result of the skill evaluation of the person included in the person information.
